(19) United States
(12) Patent Application Publication
(10) Pub. No.: US 2010/0085343 A1
(43) Pub. Date: Apr. 8, 2010

(54) ELECTROPHORETIC DISPLAY, ELECTRONIC APPARATUS, AND METHOD FOR DRIVING ELECTROPHORETIC DISPLAY

(75) Inventor: Toshimichi YAMADA, Suwa (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/555,865

(22) Filed: Sep. 9, 2009

(30) Foreign Application Priority Data
Oct. 3, 2008 (JP) 2008-258589

(51) Int. Cl. G06F 3/038

(52) U.S. Cl. 345/211; 345/107

(57) ABSTRACT

An electrophoretic display includes a first electrode, a second electrode that is provided opposite to the first electrode, an electrophoretic element being sandwiched between the first electrode and the second electrode, a pixel switching element connected to a scanning line and a data line, a memory circuit connected to the pixel switching element a switching circuit disposed between the memory circuit and the first electrodes, a first power line and a second power line connected to the memory circuit, and a first control line and a second control line connected to the switching circuit. In the electrophoretic display, at least one of the first control line and the second control line is disposed in parallel with the scanning line or the data line when viewed in plan.

### BACKGROUND

1. Technical Field

The present invention relates to an electrophoretic display, an electronic apparatus, and a method for driving the electrophoretic display.

2. Related Art

Electrophoretic displays including a switching transistor and a memory circuit in a pixel are known as active-matrix electrophoretic displays (e.g., refer to JP-A-2003-84314). In a display disclosed in JP-A-2003-84314, an electrophoretic element including a plurality of microcapsules that contain charged particles is bonded to an element substrate on which a pixel switching transistor and a pixel electrode are formed. The electrophoretic element is sandwiched between the element substrate and a counter substrate on which a counter electrode is disposed.

The pixel circuit of such an electrophoretic display is preferably laid out so as to have a small circuit area to achieve high-definition display. Thus, it is desirable to decrease the number of lines necessary in the pixel circuit. For example, in a pixel circuit of a liquid crystal display, which is one kind of display, one capacitor is generally disposed so as to correspond to one transistor. This circuit is constituted by a select transistor connected to a scanning line and a data line and a capacitor connected to a ground line or a scanning line of the adjacent pixel. The only lines that are necessary in a pixel circuit are those that connect transistors to capacitors. Thus, wiring to a ground line and the wiring area between pixel circuit elements rarely pose a problem.

In contrast, the pixel circuit of an electrophoretic display that has a latch circuit as a memory circuit includes, for example, a pair of power lines for driving the memory circuit in addition to a scanning line and a data line.

Such a pixel circuit having a latch circuit and a transmission gate needs to include a pixel switching element, a latch circuit, and a transmission gate in its one-pixel layout. Therefore, the lines connecting these components, the positive and negative power lines connected to the latch circuit, and global lines such as signal lines from the outside are required.

When global lines other than the scanning line and the data line are required for one pixel as described above, a plurality of lines may be disposed in parallel in the periphery of the pixel. In this case, the capacitance (wiring capacitance) formed between the lines is increased in accordance with the lines disposed in parallel, which decreases operation speed and increases power consumption.

### SUMMARY

An advantage of some aspects of the invention is to provide an electrophoretic display that achieves a high speed operation and a low power consumption operation, an electronic apparatus, and a method for driving the electrophoretic display.

An electrophoretic display according to an aspect of the invention includes an electrophoretic element being sandwiched between a first substrate and a second substrate and containing electrophoretic particles, in which a plurality of first electrodes respectively corresponding to a plurality of pixels are formed on the first substrate; a second electrode common to the plurality of pixels is formed on the second substrate; each of the pixels includes a pixel switching element connected to a scanning line and a data line, a memory circuit connected to the pixel switching element, and a switching circuit disposed between the memory circuit and the first electrodes; a first power line and a second power line are connected to the memory circuit; and a first control line and a second control line are connected to the switching circuit, wherein at least one of the first control line and the second control line is disposed in parallel with the scanning line or the data line when viewed in plan.

According to a first aspect of the invention, at least one of the first control line and the second control line is disposed in parallel with the scanning line or the data line when viewed in plan. When data is written to the memory circuit, the wiring capacitance formed between the at least one of the first control line and the second control line and the data line or the scanning line disposed in parallel with the one is cancelled by bringing the first control line and the second control line to a high impedance state. This provides an electrophoretic display that achieves a high speed operation and a low power consumption operation.

In the electrophoretic display described above, the scanning line and the data line preferably cross each other and the first control line and the second control line preferably cross each other.

In this case, since the scanning line and the data line cross each other and the first control line and the second control line cross each other, four lines of the scanning line, the data line, the first control line, and the second control line do not extend in parallel between the pixels. This provides an effective use of space.

In the electrophoretic display described above, the pixels adjacent to each other preferably share at least one of the first power line, the second power line, the first control line, and the second control line.

In this case, since the pixels adjacent to each other share at least one of the first power line, the second power line, the first control line, and the second control line, the number of these lines can be reduced. This can decrease the capacitance between the lines as much as possible, which contributes to an improvement in operation speed and power consumption.

In the electrophoretic display described above, planar arrangements of the pixels adjacent to each other that share at least one of the first power line, the second power line, the first control line, and the second control line are preferably line-symmetric to each other with respect to the shared line.

In this case, since the planar arrangements of the pixels that share a line are line-symmetric to each other with respect to the shared line, the number of the first power line, the second power line, the first control line, and the second control line can be reduced without significantly changing the arrangements of the lines in the pixels.

In the electrophoretic display described above, the pixels adjacent to each other preferably share at least one of the first power line and the second power line, and the scanning lines or the data lines are preferably disposed in parallel on both sides of one of the first power line and the second power line shared by the pixels adjacent to each other.

In this case, since the pixels adjacent to each other share at least one of the first power line and the second power line and the scanning lines or the data lines are disposed in parallel on both sides of the shared line, the layout of the lines can be simplified.

An electronic apparatus according to an aspect of the invention includes the electrophoretic display described above as a display section.

According to a second aspect of the invention, an electronic apparatus having a display function with high reliability can be provided because it includes an electrophoretic display that achieves a high speed operation and a low power consumption operation as a display section.

According to an aspect of the invention, a method for driving an electrophoretic display including an electrophoretic element being sandwiched between a first substrate and a second substrate and containing electrophoretic particles, in which a plurality of first electrodes respectively corresponding to a plurality of pixels are formed on the first substrate; a second electrode common to the plurality of pixels is formed on the second substrate; each of the pixels includes a pixel switching element connected to a scanning line and a data line, a memory circuit connected to the pixel switching element, and a switching circuit disposed between the memory circuit and the first electrodes; a first power line and a second power line are connected to the memory circuit; and a first control line and a second control line are connected to the switching circuit, includes the steps of disposing at least one of the first control line and the second control line in parallel with the scanning line or the data line when viewed in plan in the electrophoretic display; and bringing the at least one of the first control line and the second control line that extends in parallel with the scanning line or the data line to a high impedance state when a signal voltage is applied to the scanning line and the data line.

According to a third aspect of the invention, at least one of the first control line and the second control line is disposed in parallel with the scanning line or the data line when viewed in plan. In addition, the at least one of the first control line and the second control line that extends in parallel with the scanning line or the data line is brought to a high impedance state when a signal voltage is applied to the scanning line and the data line. Therefore, when data is written to the memory circuit, the wiring capacitance formed between the at least one of the first control line and the second control line and the data line or the scanning line disposed in parallel with the one is cancelled. This provides an electrophoretic display that achieves a high speed operation and a low power consumption operation.

### BRIEF DESCRIPTION OF THE DRAWINGS

The invention will be described with reference to the accompanying drawings, wherein like numbers reference like elements.

FIG. 1 is a schematic view of an electrophoretic display according to a first embodiment of the invention.

FIG. 2 is a circuit diagram of a pixel of the electrophoretic display according to this embodiment.

FIG. 3 is a fragmentary sectional view of the electrophoretic display according to this embodiment.

FIG. 4 is a sectional view of a microcapsule of the electrophoretic display according to this embodiment.

FIG. 5 is a plan view showing a structure of one pixel of the electrophoretic display according to this embodiment.

FIGS. 6A and 6B show one example of an electronic apparatus having an electrophoretic display according to an embodiment of the invention.

FIG. 7 shows one example of an electronic apparatus having an electrophoretic display according to an embodiment of the invention.

FIG. 8 shows one example of an electronic apparatus having an electrophoretic display according to an embodiment of the invention.

FIG. 9 is a plan view showing another structure of one pixel of the electrophoretic display according to this embodiment.

FIG. 10 is a plan view showing another structure of one pixel of the electrophoretic display according to this embodiment.

### DESCRIPTION OF EXEMPLARY EMBODIMENTS

An embodiment of the invention will now be described with reference to the drawings. In this embodiment, an active-matrix electrophoretic display is exemplified. The scales and numbers in the drawings are differentiated from those of the actual structure for the purpose of clarification.

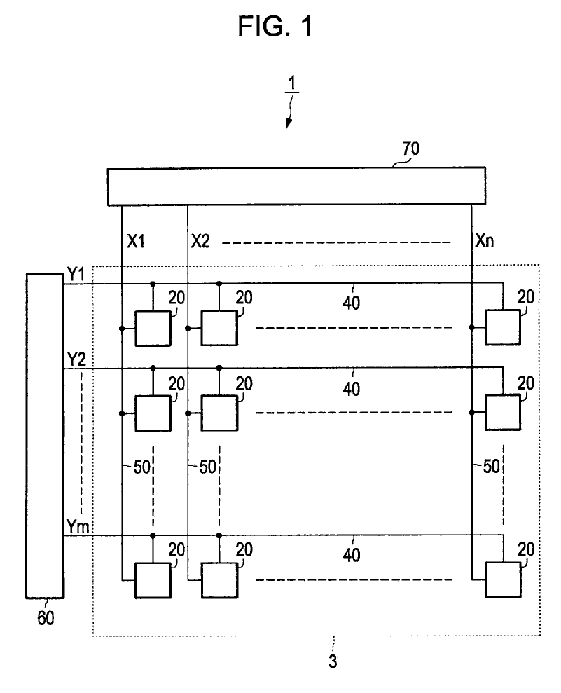

FIG. 1 is a plan view showing a general structure of an electrophoretic display 1 according to this embodiment. The electrophoretic display 1 includes a display section 3 in which a plurality of pixels 20 are arranged, a scanning line driving circuit 60, and a data line driving circuit 70.

A plurality of scanning lines 40 (Y1, Y2, . . . , Ym) extending from the scanning line driving circuit 60 and a plurality of data lines 50 (X1, X2, . . . , Xn) extending from the data line driving circuit 70 are formed in the display section 3. The pixels 20 are arranged so as to correspond to intersection points of the scanning lines 40 and the data lines 50. Each of the pixels 20 is connected to one of the scanning lines 40 and one of the data lines 50.

In addition to the scanning line driving circuit 60 and the data line driving circuit 70, a common power supply modulation circuit (not shown) and a controller (not shown) are disposed in the periphery of the display section 3. The controller entirely controls the circuits described above in accordance with image data or synchronizing signals supplied from a host apparatus.

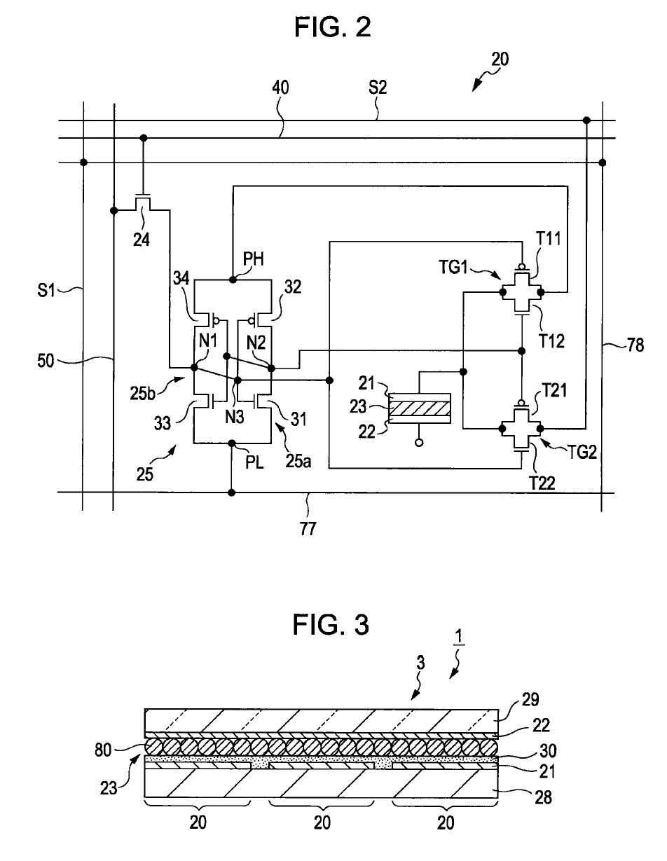

In addition to the scanning line 40 and the data line 50, a high potential power line 78 (first power line), a low potential power line 77 (second power line), a first control line S1, and a second control line S2 are connected to each of the pixels 20 from the common power supply modulation circuit (for example, refer to FIG. 2). The common power supply modulation circuit generates various signals that need to be supplied to the lines described above while electrically connects and disconnects (bringing to a high impedance state) these lines on the basis of control of the controller.

FIG. 2 shows a circuit structure of the pixel 20. The pixel 20 includes a pixel switching element 24, a latch circuit (memory circuit) 25, transmission gates TG1 and TG2 that are switching circuits for potential control, a pixel electrode 21, a common electrode 22, and an electrophoretic element 23.

The pixel switching element 24 is an n-type field-effect transistor. The pixel switching element 24 has a gate terminal connected to the scanning line 40, a source terminal connected to the data line 50, and a drain terminal connected to an input terminal N1 of the latch circuit 25. The scanning line 40 is orthogonal to the data line 50 in the top left corner of the pixel 20 in the drawing.

The latch circuit 25 including a transfer inverter 25a and a feedback inverter 25b corresponds to a static random access memory (SRAM) cell.

The transfer inverter 25a has an output terminal connected to the input terminal of the feedback inverter 25b and an input terminal connected to the output terminal of the feedback inverter 25b. In other words, an input terminal of one of the transfer inverter 25a and the feedback inverter 25b is connected to an output terminal of the other. Thus, the transfer inverter 25a and the feedback inverter 25b have a loop structure. The input terminal of the transfer inverter 25a (the output terminal of the feedback inverter 25b) is an input terminal N1 of the latch circuit 25 while the output terminal of the transfer inverter 25a (the input terminal of the feedback inverter 25b) is an output terminal N2 of the latch circuit 25. A high potential power terminal PH of the latch circuit 25 is connected to the high potential power line 78 while a low potential power terminal PL thereof is connected to the low potential power line 77. The high potential power line 78 is arranged so as to be orthogonal to the low potential power line 77 in each of the pixels 20.

The transfer inverter 25a includes an n-type transistor 31 and a p-type transistor 32. The n-type transistor 31 and the p-type transistor 32 each has a gate terminal connected to the input terminal N1 of the latch circuit 25. The n-type transistor 31 has a source terminal connected to the low potential power line 77 and a drain terminal connected to the output terminal N2. The p-type transistor 32 has a source terminal connected to the high potential power line 78 and a drain terminal connected to the output terminal N2.

The feedback inverter 25b includes an n-type transistor 33 and a p-type transistor 34. The n-type transistor 33 and the p-type transistor 34 each has a gate terminal connected to the output terminal N2 (the drain terminals of the n-type transistor 31 and the p-type transistor 32) of the latch circuit 25. The n-type transistor 33 has a source terminal connected to the low potential power line 77 and a drain terminal connected to the input terminal N1. The p-type transistor 34 has a source terminal connected to the high potential power line 78 and a drain terminal connected to the input terminal N1.

The transmission gate TG1 includes a p-type field-effect transistor T11 and an n-type field-effect transistor T12. The source terminal of the p-type transistor T11 is connected to the source terminal of the n-type transistor T12, and these source terminals are connected to the first control line S1. The drain terminal of the p-type transistor T11 is connected to the drain terminal of the n-type transistor T12, and these drain terminals are connected to the pixel electrode 21. The gate terminal of the p-type transistor T11 is connected to the input terminal N1 of the latch circuit 25, and the gate terminal of the n-type transistor T12 is connected to the output terminal N2 of the latch circuit 25.

The transmission gate TG2 includes a p-type field-effect transistor T21 and an n-type field-effect transistor T22. The source terminal of the p-type transistor T21 is connected to the source terminal of the n-type transistor T22, and these source terminals are connected to the second control line S2. The drain terminal of the p-type transistor T21 is connected to the drain terminal of the n-type transistor T22, and these drain terminals are connected to the pixel electrode 21.

The gate terminal of the p-type transistor T21 is connected to the output terminal N2 of the latch circuit 25 together with the gate terminal of the n-type transistor T12 of the transmission gate TG1. The gate terminal of the n-type transistor T22 is connected to the input terminal N1 of the latch circuit 25 together with the gate terminal of the p-type transistor T11 of the transmission gate TG1.

The first control line S1 is disposed in parallel with the data line 50. The second control line S2 is disposed in parallel with the scanning line 40. The first control line S1 is orthogonal to the second control line S2 in the top left corner of the pixel 20 in the drawing. In this specification, it is described that two lines among the scanning line 40, the data line 50, the low potential power line 77, the high potential power line 78, the first control line S1, and the second control line S2 are orthogonal to each other or cross each other. This description represents an arrangement when viewed in plan. In reality, the lines orthogonal to each other or crossing each other are disposed in different layers that are stacked through an insulating layer.

FIG. 3 is a fragmentary sectional view of the electrophoretic display 1 in the display section 3. The electrophoretic display 1 includes the electrophoretic element 23 having a plurality of microcapsules 80. The electrophoretic element 23 is sandwiched between an element substrate 28 and a counter substrate 29.

In the display section 3, a plurality of pixel electrodes 21 are arranged on the electrophoretic element 23 side of the element substrate 28, and the electrophoretic element 23 is bonded to the pixel electrodes 21 through an adhesive layer 30. A common electrode 22 having a planar shape that faces the plurality of pixel electrodes 21 is formed on the electrophoretic element 23 side of the counter substrate 29, and the electrophoretic element 23 is disposed on the common electrode 22.

The element substrate 28 is composed of, for example, glass or plastic. The element substrate 28 is not necessarily transparent because it is disposed on the side opposite to an image display surface. Although omitted in the drawing, the scanning lines 40, the data lines 50, the pixel switching elements 24, the latch circuits 25, and the like shown in FIGS. 1 and 2 are formed between the pixel electrodes 21 and the element substrate 28.

The counter substrate 29 is composed of, for example, glass or plastic. The counter substrate 29 needs to be transparent because it is disposed on the image display surface side. The common electrode 22 formed on the counter substrate 29 is composed of a transparent conductive material such as MgAg, indium tin oxide (ITO), or indium zinc oxide (IZO).

The electrophoretic element 23 is formed on the counter substrate 29 side in advance, and is generally treated as an electrophoretic sheet that also includes the adhesive layer 30. In addition, a release paper for protection is attached on the surface of the adhesive layer 30.

In the manufacturing process, the display section 3 is formed by bonding the electrophoretic sheet whose release paper has been removed to the element substrate 28 that has been separately manufactured and on which the pixel electrodes 21 and the circuits described above have been formed. Therefore, the adhesive layer 30 is present only on the pixel electrodes 21 side but not on the common electrode 22 side.

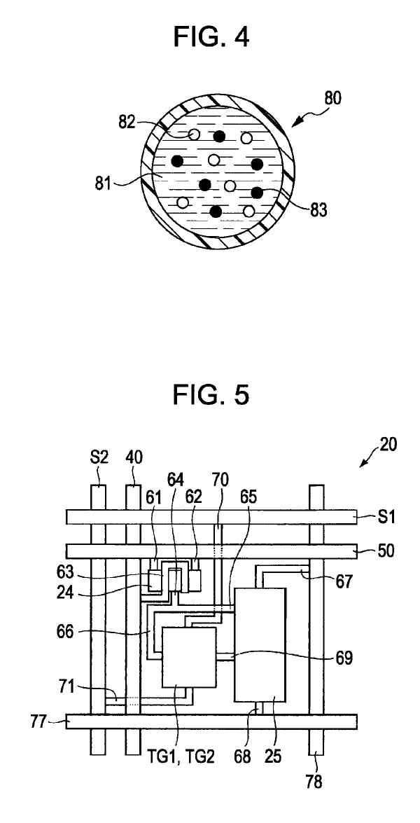

FIG. 4 is a schematic sectional view of the microcapsules 80. Each of the microcapsules 80 has a spherical body with a particle size of, for example, about 50 μm and contains a dispersion medium 81, a plurality of white particles (electrophoretic particles) 82 and a plurality of black particles (electrophoretic particles) 83. The microcapsules 80 are sandwiched between the common electrode 22 and the pixel electrodes 21 as shown in FIG. 3. In one of the pixels 20, one or more microcapsules 80 are disposed.

The shell (wall film) of the microcapsules 80 is composed of, for example, an acrylic resin such as polymethyl methacrylate or polyethyl methacrylate, a urea resin, or a transparent polymer resin such as gum arabic.

The dispersion medium 81 is a liquid for dispersing the white particles 82 and the black particles 83 in the microcapsules 80. Examples of the dispersion medium 81 include water, alcohol solvents (methanol, ethanol, isopropanol, butanol, octanol, methyl cellosolve, etc.), esters (ethyl acetate, butyl acetate, etc.), ketones (acetone, methyl ethyl ketone, methyl isobutyl ketone, etc.), aliphatic hydrocarbons (pentane, hexane, octane, etc.), alicyclic hydrocarbons (cyclohexane, methylcyclohexane, etc.), aromatic hydrocarbons (benzene, toluene, and benzenes with a long-chain alkyl group (xylene, hexylbenzene, heptylbenzene, octylbenzene, nonylbenzene, decylbenzene, undecylbenzene, dodecylbenzene, tridecylbenzene, tetradecylbenzene, etc.)), halogenated hydrocarbons (methylene chloride, chloroform, carbon tetrachloride, 1,2-dichloroethane, etc.), carboxylates, and other oils. These materials may be used alone or in combination. A surfactant may be further added.

The white particles 82 (polymer or colloid) are composed of a white pigment such as titanium dioxide, zinc oxide, or antimony trioxide, and are used as, for example, negatively charged particles. The black particles 83 (polymer or colloid) are composed of a black pigment such as aniline black or carbon black, and are used as, for example, positively charged particles.

A charge control agent composed of particles of, for instance, an electrolyte, a surfactant, a metallic soap, a resin, a rubber, an oil, a varnish, or a compound; a dispersant such as a titanium coupling agent, an aluminum coupling agent, or a silane coupling agent; a lubricant; a stabilizer; and the like can be optionally added to the pigments.

FIG. 5 is a plan view specifically showing a structure of one of the pixels 20 in the electrophoretic display 1 according to this embodiment.

The scanning line 40, the data line 50, the high potential power line 78, the low potential power line 77, the first control line S1, and the second control line S2 are disposed around the perimeter of the pixel 20. These lines are formed across the plurality of pixels 20.

The scanning line 40 is disposed on the left side of the perimeter of the pixel 20 in the drawing and extends in an up-down direction of the drawing. The data line 50 is disposed on the upper side of the perimeter of the pixel 20 in the drawing and extends in a left-right direction of the drawing. The scanning line 40 is orthogonal to the data line 50 in the top left corner of the pixel 20 in the drawing.

The first control line S1 is disposed on the upper side of the perimeter of the pixel 20 in the drawing and extends in a left-right direction of the drawing in parallel with the data line 50. The first control line S1 is disposed at an outer side of the pixel 20 relative to the data line 50 (upper side in the drawing). The second control line S2 is disposed on the left side of the perimeter of the pixel 20 in the drawing and extends in an up-down direction of the drawing in parallel with the scanning line 40. The second control line S2 is disposed at an outer side of the pixel 20 relative to the scanning line 40 (left side in the drawing). The first control line S1 is orthogonal to the second control line S2 in the top left corner of the pixel 20 in the drawing.

The high potential power line 78 is disposed on the right side of the perimeter of the pixel 20 in the drawing and extends in an up-down direction of the drawing. The low potential power line 77 is disposed on the lower side of the perimeter of the pixel 20 in the drawing and extends in a left-right direction of the drawing. The high potential power line 78 is orthogonal to the low potential power line 77 in the bottom right corner of the pixel 20 in the drawing.

A structure in the pixel 20 will now be described. The pixel switching element 24, the latch circuit 25, and the transmission gates TG1 and TG2 are disposed in the pixel 20 as described above. In addition, wiring is formed for connecting each of the components. The pixel switching element 24 is disposed at the top left portion of the pixel 20 in the drawing. The pixel switching element 24 includes a double gate semiconductor film (not shown).

The semiconductor film has two channel regions, two source regions, and a drain region. The two source regions of the semiconductor film are connected to the data line 50 through a line 61 and a line 62, respectively. A line 63 that also functions as a gate electrode is disposed on the two channel regions of the semiconductor film. The line 63 is connected to the scanning line 40, and the portion that overlaps with the semiconductor film functions as a gate electrode. A line 64 is connected to the drain region of the semiconductor film. The line 64 has branch portions 65 and 66. The branch portion 65 is connected to the latch circuit 25. The branch portion 66 is connected to the transmission gates TG1 and TG2.

The latch circuit 25 is disposed at the right portion of the pixel 20 in the drawing. The latch circuit 25 is connected to the high potential power line 78 through a line 67 and to the low potential power line 77 through a line 68. The latch circuit 25 is connected to the transmission gates TG1 and TG2 through a line 69.

The transmission gate TG1 (e.g., upper side in the drawing) is connected to the first control line S1 through a line 70. The line 70 is formed, for example, so as to pass under the data line 50 and the branch portion 65. The transmission gate TG2 (e.g., lower side in the drawing) is connected to the second control line S2 through a line 71. The line 71 is formed, for example, so as to pass under the scanning line 40.

In the pixel 20 having the structure described above, when low level image data is input to the latch circuit 25 from the data line 50 through the pixel switching element 24, a low level is output from the input terminal N1 of the latch circuit 25 and a high level is output from the output terminal N2 thereof. Therefore, only the p-type transistor T11 and the n-type transistor T12 constituting the transmission gate TG1 are turned on. Consequently, the pixel electrode 21 is electrically connected to the first control line S1.

In contrast, when high level image data is input to the latch circuit 25 from the data line 50 through the pixel switching element 24, a high level is output from the input terminal N1 of the latch circuit 25 and a low level is output from the output terminal N2 thereof. Therefore, only the p-type transistor T21 and the n-type transistor T22 constituting the transmission gate TG2 are turned on. Consequently, the pixel electrode 21 is electrically connected to the second control line S2.

In this circuit structure, the electric potentials applied to the first control line S1 and the second control line S2 can be separately controlled using the common power supply modulation circuit. Thus, the same electric potential can be applied to all the pixel electrodes, regardless of which transmission gate is turned on.

Accordingly, a display state can be changed to full black, full white, and a reverse image while image data is held in the latch circuit (regardless of the held data). A driver circuit is not necessarily operated unless a new image is displayed, which achieves a more flexible displaying method.

In the electrophoretic display 1 of this embodiment, when data is written to the latch circuit 25 using the scanning line 40 and the data line 50, the first control line S1 and the second control line S2 are brought to a high impedance state. In this embodiment, the first control line S1 and the second control line S2 are disposed in parallel with the data line 50 and the scanning line 40, respectively, when viewed in plan. When the data is written to the latch circuit 25, the wiring capacitances formed between the first control line S1 and the data line 50 and between the second control line S2 and the scanning line 40 are cancelled. This provides an electrophoretic display 1 that achieves a high speed operation and a low power consumption operation.

### Electronic Apparatus

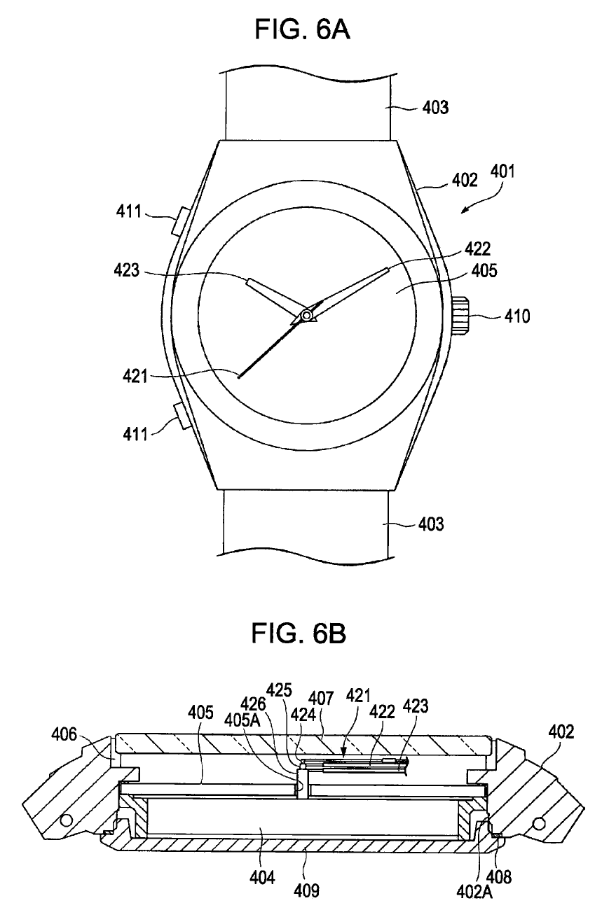

An electronic apparatus according to the invention will now be described. FIG. 6A is a front view of a wristwatch 401 with the electrophoretic display 1 according to the invention.

The wristwatch 401 includes a watch case 402 and a pair of bands 403 joined to the watch case 402. A display device 405 constituted by the electrophoretic display 1 according to the invention, a second hand 421, a minute hand 422, and an hour hand 423 are disposed on the front of the watch case 402. A crown 410 and an operating button 411 are disposed as operating members on the side face of the watch case 402.

FIG. 6B is a sectional side view of the wristwatch 401. A housing portion 402A is formed in the watch case 402. The housing portion 402A contains a movement 404 and the display device 405. A transparent cover 407 made of glass or resin is fitted to one side (front side of the watch) of the housing portion 402A. A back cover 409 is screwed into the other side (back side of the watch) of the housing portion 402A with a gasket disposed therebetween. The back cover 409 and the transparent cover 407 ensure the hermeticity of the watch case 402.

The movement 404 has a hand movement mechanism (not shown) joined to analog hands constituted by the second hand 421, the minute hand 422, and the hour hand 423. The hand movement mechanism rotates the analog hands 421 to 423, thus functioning as a time display section for displaying the set time.

The display device 405 is disposed on the front side of the movement 404 to constitute a display section of the wristwatch 401. The display device 405 has a circular display surface, but may have, for example, a regular octagonal or hexadecagonal display surface. A through-hole 405A that penetrates from the front to the back of the display device 405 is formed in the center of the display device 405. The shafts of a second wheel 424, a center wheel 425, and an hour wheel 426 of the hand movement mechanism (not shown) of the movement 404 protrude from the through-hole 405A. The second hand 421, the minute hand 422, and the hour hand 423 are attached to the ends of the respective wheels 424 to 426.

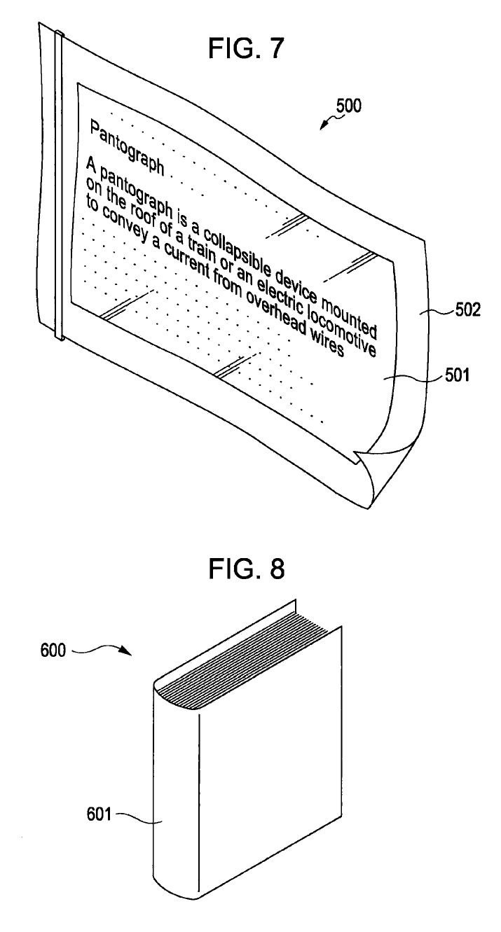

The electrophoretic display of the invention can be applied to electronic apparatuses other than a watch. FIG. 7 is a perspective view showing a structure of electronic paper 500. A sheet of electronic paper 500 includes the electrophoretic display of the invention as a display section 501. The electronic paper 500 is flexible and includes a sheet body 502 composed of a rewritable sheet with texture and flexibility similar to existing paper.

FIG. 8 is a perspective view showing a structure of an electronic note 600. The electronic note 600 has a structure in which multiple sheets of electronic paper 500 shown in FIG. 7 are bundled and placed between covers 601. The covers 601, for example, include a display data input unit (not shown) for inputting display data transmitted from an external apparatus. Accordingly, the display information can be changed or updated in accordance with the display data while the multiple sheets of electronic paper are bundled.

With the electrophoretic display of the invention, the wristwatch 401, the electronic paper 500, and the electronic note 600 described above certainly include a display section with high reliability.

Technical scope of the invention is not limited to the embodiments described above and can be suitably modified without departing from the scope of the invention. In the embodiment described above, for example, the six lines such as the scanning line 40, the data line 50, the high potential power line 78, the low potential power line 77, the first control line S1, and the second control line S2 are disposed in each of the pixels 20. However, the invention is not limited to such a structure.

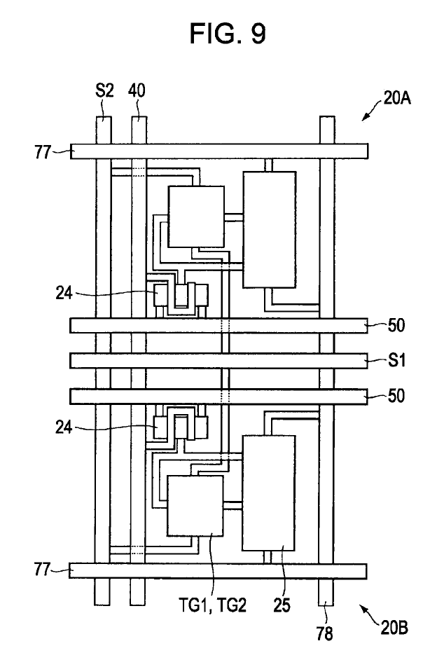

FIG. 9 is a plan view showing a structure of two pixels 20A and 20B adjacent to each other. In FIG. 9, the reference numerals of lines are omitted to clarify the drawing. A pixel on the upper side of the drawing is defined as the pixel 20A and a pixel on the lower side of the drawing is defined as the pixel 20B. As shown in FIG. 9, the first control line S1 may be shared by the pixels 20A and 20B adjacent to each other.

In the structure shown in FIG. 9, the scanning line 40 and the second control line S2 are disposed across the pixels 20A and 20B. These lines are used as common lines for the pixels 20A and 20B. The arrangements in the pixels 20A and 20B are line-symmetric to each other with respect to the first control line S1. The data line 50 for the pixel 20A and the data line 50 for the pixel 20B are disposed so as to sandwich the first control line S1.

By disposing the pixels 20A and 20B as described above, the number of the first control line S1 can be decreased without significantly changing the actual arrangements of lines in the pixels. This ensures larger spaces of the pixels 20A and 20B, which provides a sufficient distance between the lines formed in the pixels 20A and 20B.

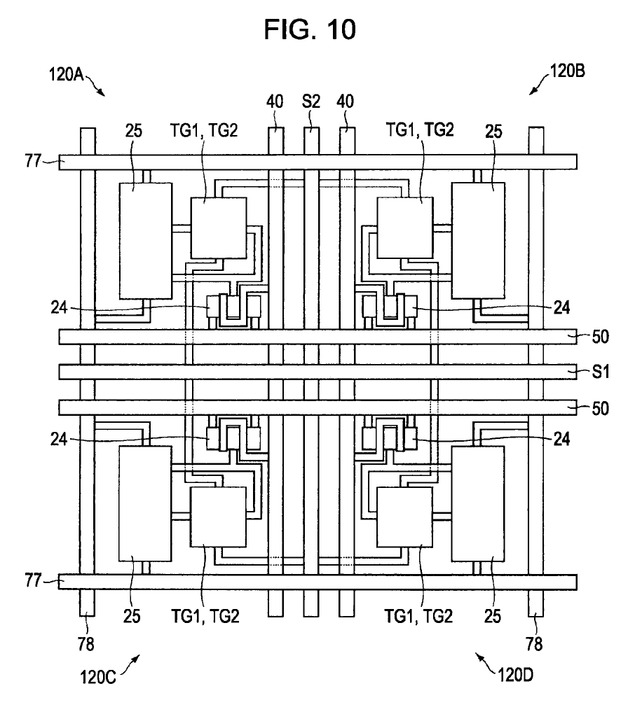

FIG. 10 is a plan view showing a structure of four pixels 120A, 120B, 120C, and 120D adjacent to each other. In FIG. 10, the reference numerals of lines are omitted to clarify the drawing as in FIG. 9. Pixels on the upper left side, on the upper right side, on the lower left side, and on the lower right side of the drawing are defined as the pixels 120A, 120B, 120C, and 120D, respectively. As in the case of FIG. 9, the first control line S1 and the second control line S2 may be shared by the pixels 120A, 120B, 120C, and 120D adjacent to each other as shown in FIG. 10.

In this structure, the data line 50 for the pixels 120A and 120B and the data line 50 for the pixels 120C and 120D are disposed so as to sandwich the first control line S1. The scanning line 40 for the pixels 120A and 120C and the scanning line 40 for the pixels 120B and 120D are disposed so as to sandwich the second control line S2.

In this case, the arrangements in the pixels 120A and 120B are line-symmetric to each other with respect to the second control line S2. The arrangements in the pixels 120C and 120D are line-symmetric to each other with respect to the second control line S2. The arrangements in the pixels 120A and 120C are line-symmetric to each other with respect to the first control line S1. The arrangements in the pixels 120B and 120D are line-symmetric to each other with respect to the first control line S1.

By providing such a structure, the number of the first control line S1 and the second control line S2 can be decreased without significantly changing the actual arrangements of lines in the pixels. This ensures larger spaces of the pixels 120A to 120D, which provides a sufficient distance between the lines formed in the pixels 120A to 120D.

In the above description, three structures such as a structure in which the first control line S1 is not shared (FIG. 5), a structure in which only the first control line S1 is shared (FIG. 9), and a structure in which both the first control line S1 and the second control line S2 are shared have been exemplified. However, the invention can be obviously applied to another structure such as a structure in which only the second control line S2 is shared (not shown). The arrangements in the pixels that are adjacent to each other so as to sandwich the shared second control line S2 are line-symmetric to each other with respect to the second control line S2.

In the above description, the lines in the pixel 20 have been laid out as in FIGS. 5, 9, and 10 (the lines 61 to 71 in FIG. 5). However, the invention is not limited to such a structure, and lines may be laid out in a different manner.

In the above description, the first control line S1 has been disposed in parallel with the data line 50 and the second control line S2 has been disposed in parallel with the scanning line 40. However, the invention is not limited to such a structure. For example, the first control line S1 may be disposed in parallel with the scanning line 40 and the second control line S2 may be disposed in parallel with the data line 50.

The entire disclosure of Japanese Patent Application No. 2008-258589, filed Oct. 3, 2008 is expressly incorporated by reference herein.

What is claimed is:

1. An electrophoretic display comprising:
a first electrode;
a second electrode that is provided opposite to the first electrode;
an electrophoretic element being sandwiched between the first electrode and the second electrode;
a pixel switching element connected to a scanning line and a data line;
a memory circuit connected to the pixel switching element;
a switching circuit disposed between the memory circuit and the first electrodes;
a first power line and a second power line connected to the memory circuit; and
a first control line and a second control line connected to the switching circuit,
wherein at least one of the first control line and the second control line is disposed in parallel with the scanning line or the data line when viewed in plan.

2. The electrophoretic display according to claim 1,
wherein the scanning line and the data line cross each other; and
the first control line and the second control line cross each other.

3. The electrophoretic display according to claim 1,
wherein the electrophoretic display includes a plurality of pixels, and each of the plurality of pixels has the first electrode, the second electrode, the electrophoretic element, the pixel switching element, the memory circuit, the switching circuit, the first power line and the second power line, the first control line and the second control line, and
wherein the pixels adjacent to each other share at least one of the first power line, the second power line, the first control line, and the second control line.

4. The electrophoretic display according to claim 3,
wherein planar arrangements of the pixels adjacent to each other that share at least one of the first power line, the second power line, the first control line, and the second control line are line-symmetric to each other with respect to the shared line.

5. The electrophoretic display according to claim 3,
wherein the pixels adjacent to each other share at least one of the first power line and the second power line; and
the scanning lines or the data lines are disposed in parallel on both sides of one of the first power line and the second power line shared by the pixels adjacent to each other.

6. An electronic apparatus comprising the electrophoretic display according to claim 1 as a display section.

7. A method for driving an electrophoretic display, the electrophoretic display including:
a first electrode;
a second electrode that is provided opposite to the first electrode;
an electrophoretic element being sandwiched between the first electrode and the second electrode;
a pixel switching element connected to a scanning line and a data line;
a memory circuit connected to the pixel switching element;
a switching circuit disposed between the memory circuit and the first electrodes;
a first power line and a second power line connected to the memory circuit; and
a first control line and a second control line connected to the switching circuit, and
wherein at least one of the first control line and the second control line is disposed in parallel with the scanning line or the data line when viewed in plan, and
the method comprising:
bringing the at least one of the first control line and the second control line that extends in parallel with the scanning line or the data line to a high impedance state when a signal voltage is applied to the scanning line and the data line.
